(19) United States
(12) Patent Application Publication
(10) Pub. No.: US 2026/0035315 A1
(43) Pub. Date: Feb. 5, 2026

(54) ENVIRONMENTALLY-FRIENDLY SURFACTANTS FOR ANTICAKING AND MOISTURE RESISTANCE COATINGS FOR HYGROSCOPIC SUBSTRATES

(71) Applicant: Colonial Chemical, Inc., South Pittsburg, TN (US)

(72) Inventors: Lucas R. Moore, South Pittsburg, TN (US); Robert N. Comber, South Pittsburg, TN (US); Garret Bryant, Rocky Face, GA (US)

(21) Appl. No.: 19/101,508

(22) PCT Filed: Aug. 7, 2023
(86) PCT No.: PCT/US2023/029671

§ 371 Date: Feb. 5, 2025

Related U.S. Application Data
(60) Provisional application No. 63/395,508, filed on Aug. 5, 2022.

(51) Int. Cl. C05G 3/30; C05C 1/02; C05G 5/12; C05G 5/30

(52) U.S. Cl. CPC C05G 3/30; C05C 1/02; C05G 5/12; C05G 5/37

(57) ABSTRACT

A composition for a anticaking coating additive, which comprises: derivatized carbohydrates like alkyl derivatized polyglycosides, glycolipids, glycerol glycolipids, sphingo glycolipids, sulfolipids, phospholipids, glucosides, rhamnolipids, sophorolipids, and others.

### PRIOR APPLICATIONS

This application claims benefit of U.S. Patent Application No. 63/395,508, filed Aug. 5, 2022; the contents of which are incorporated herein by reference.

### BACKGROUND OF THE INVENTION

The present invention includes compositions and methods for coating a hygroscopic substrate such as a fertilizer or other granular products to prevent caking and/or crusting, and in the case of fertilizers, enhance the delivery of nutrients.

Fertilizers are generally organic or inorganic materials of natural or synthetic origin that, when added to a soil, enrich that soil in substances which constitute essential nutrients to the growth of plants. Fertilizers can be liquid or solid, being alternatively used depending on the purpose. Liquid fertilizers provide fast and direct nourishment for the plants, while solid fertilizers nourish the soil microorganisms, acting therefore as slow releasers of the nutrients. Among solid fertilizers, two of the most generally used types are granular simple fertilizers and granular complex fertilizers.

Granular simple fertilizers include primary macronutrients, potassium, phosphorous or nitrogen compounds assimilable by plants. Some examples are potassium chloride (KCl), ammonium nitrate (AN), and calcium nitrate (CN), mono- and diammonium phosphates and urea-based fertilizers.

Granular complex fertilizers include combinations of more than one primary macronutrient. They are usually called NPK and can be differentiated from one another mainly because of their nitrogen, phosphorous and potassium content, expressed as the percentage of nitrogen (N), phosphoric anhydride (P₂O₅) and potassium oxide (K₂O) that the complex fertilizer contains.

Fertilizers are organic or inorganic materials of natural or synthetic origin (other than liming materials) that, when added to a soil, enrich that soil in substances which constitute essential nutrients to the growth of plants.

Solid fertilizers in particular are known to have, as a main application problem, unless treated to avoid it, of experiencing caking phenomenon during storage. This agglomeration can be very dependent on the temperature, humidity and pressure conditions. If not avoided, the agglomeration of the fertilizer results into the formation of large, agglomerated fertilizer lumps. The bigger the lumps, the more difficult to mix the fertilizer with the soil, causing the loss of the fertilizer efficiency. The agglomeration may further cause the formation of a crust on the surface of the fertilizer. Thus, the caking and crust formation of fertilizers is a major drawback when dosing and applying them, and it also has an impact in economic losses.

Fertilizers and other granular products (i.e. low density ammonium nitrate (LDAN)) are generally hygroscopic, which is needed to ensure dissolution and end with nutrient and micronutrient uptake by the plants. However, they are not a mechanical device where this function can be turned on as needed. Therefore, they will adsorb moisture out of the air. This is especially problematic for the more humid regions like Florida, Brazil, etc. where the humidity can become quite high. As a consequence of moisture adsorption, the fertilizers can slowly dissolve and re-precipitate as the natural humidity fluctuates through the day. This process causes the fertilizers to lose shape, size, and even begin building mass and size by the interactions with other granules. This is especially problematic for the nitrate based granules/fertilizers, which is even further exaggerated by the combination with other granule types. For example, calcium nitrate has a critical relative humidity of 46.7, but this will be lowered to 23.5 when combined with ammonium nitrate, which is independently at 59.4.

A common solution used to reduce both the caking problem and the dust formation problem is the addition to the fertilizer of an anticaking and antidusting additive. Said additive can be applied to the fertilizer just recently manufactured or after a curing period in the warehouse. The fertilizer is treated with a fluid composition comprising the active anticaking compound in order a protective coating comprising said additive is formed over the fertilizer particles' or granules' surface; the coating quickly solidifies or acquires sufficient viscosity in contact with the solid fertilizer, and provides protection from the caking and dusting disadvantages.

Also in the field of fertilizers industry there exists an increasing demand of more environmentally friendly and more easily biodegradable products. Of course, this also applies for fertilizer anticaking additives. In this regard, the use of surface active agents with reduced eco-toxicity and lower bioaccumulation potential to prevent environmental issues is of particular interest. Such a trend is reflected also by the changes in the regulations affecting this field. For instance, legislation in Europe is being more severe in the use of fertilizer anticaking additives with low ecological profile in order to ensure that they do not become an environmental risk.

Therefore there is a need for additives that meet environmental standards and that give good results in caking prevention for solid fertilizer particles.

One embodiment of the present invention is a coating applied to assist with building a layer around the granule to prevent the uptake of moisture, as well as disrupt the agglomeration of caking between substrate granules or particles. The coatings generally contain moisture resistant chemistry. Examples include a coating that is like a wax or some form of a crystal modifier to disrupt the crystal growth associated with caking or agglomeration. They may contain a carrier oil to help deliver those components. In some occasions, the surfactants may be dissolved in water or a polar solvent and applied to the substrate as an aqueous coating.

It is herein proposed that a new class of natural surfactants derived from carbohydrates like sugars, that will be further functionalized by chemical modification that can be used with these hydrophobic waxes and some carrier. The hydrophobic component may be petro and natural based oils and waxes.

### SUMMARY OF VARIOUS EMBODIMENTS OF THE INVENTION

Typically, a product of the present invention is a combination of a granular dry component and a liquid or waxy component coated on at least a portion of the dry component, the liquid component including a composition of the present invention. When blended, the present invention provides granules with a coating. After coating and drying, the granules resisting caking when packaged.

Another embodiment of the present invention is a coating agent for hydroscopic substrates that comprises an active component/surfactant, a carrier, and optional additional hydrophobic components.

One embodiment of the present invention is a composition for a anticaking coating additive, comprising derivatized carbohydrates to produce things like alkyl derivatized polyglycosides, glycolipids, glycerol glycolipids, sphingo glycolipids, sulfolipids, phospholipids, glucosides, rhamnolipids, sophorolipids, and others.

Another embodiment of the present invention is a coating composition comprising a crosspolymer of an alkyl polyglucoside.

Another embodiment of the present invention is the use of derivatized alkyl polyglucosides as the anticaking coating additive (surfactant).

Another embodiment of the present invention is a coating for the following substrates including, but not limited to, monoammonium phosphate (MAP), di-ammonium phosphate (DAP), Single Super Phosphate (SSP), Triple Super Phosphate (TSP), ammonium nitrate (AN), LDAN, AS, NPK, KCl, polyhalite, and KSO4, and any homogenous or blended combination.

In another embodiment of the present invention, the derivatized alkyl polyglucoside is chosen from a carboxymethyl derivatized alkyl polyglucoside, a quaternary derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

In another embodiment of the present invention, the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

In another embodiment of the present invention, the present invention is a sorbitan oleate decylglucoside crosspolymer. It should be understood that other crosspolymers can include other alkyl polyglucosides (for example, lauryl polyglucoside), and other sorbitan esters (for example, sorbitan laurate, sorbitan stearate, sorbitan myristate, and sorbitan palmitate).

In another In another embodiment of the present invention, the derivatized polyglucoside surfactant of the present invention comprises a monosaccharide unit, a disaccharide unit, a linker, and a functionalizing agent.

In another embodiment of the present invention, the derivatized polyglucoside surfactant of the present invention comprises a monosaccharide unit, a disaccharide unit, a linker, a crosslinking agent, and a functionalizing agent.

In another embodiment of the present invention, the composition further comprises a co-surfactant.

In one embodiment, the coating complex may be a surfactant of the present invention at a dosage of about 5 to about 30%, or more specifically a combination to yield 15% in a formula that contains 35-100% wax (petro wax or palm stearin, or lecithin), and the balance being an oil (veg based oils like soybean oil, petro oil like paraffinic or naphthenic oils). The surfactant of the present invention can be combined with other surfactants. Examples include stearyl amine, stearic acid, octadecyl phosphate ester.

In one embodiment, an example is about 7.5% of a surfactant of the present invention, about 7.5% octadecyl phosphate ester, and about 85% palm stearin. In another embodiment, an example is about 15% of a surfactant of the present invention and about 85% synthetic FT waxes. In another embodiment, an example is about 20% of a blend of our surfactants, about 30% lecithin and about 50% soybean oil.

In one example, a coating agent if the present invention is a hydrophobic component, an active pack (surfactant, additive, active component), a carrier (oil or the hydrophobic component—some cases the hydrophobic component can also be the carrier). So, as used herein the term additives and active components may be used interchangeably with the term surfactant. The surfactants of the present invention enhance a coating formulation by disrupting, preventing, or minimizing crystal bridging between substrate particles to which the coating is applied (i.e. NPK fertilizer granules).

In another object of the present invention is a solid fertilizer resistant to caking, wherein solids are coated by a composition according to the present invention.

Another embodiment of the invention is the use of a composition of the present invention for preventing the caking of solid fertilizers.

### DETAILED DESCRIPTION OF THE INVENTION

The details of one or more embodiments of the presently disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by those of ordinary skill in the art, certain definitions are set forth to facilitate explanation of the presently disclosed subject matter.

Unless defined otherwise, all technical and scientific terms used herein have the same meaning as is commonly understood by one of skill in the art to which the invention(s) belong.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which need to be independently confirmed.

As discussed above, an object of the present invention is a composition for preventing the caking of granular particles, comprising an active/surfactant and a carrier. With respect to the surfactant, the compositions of the present invention are many times mixtures of alkyl polyglucosides, and optionally a linker arm, and optionally a functionalizing agent, and optionally a crosslinking agent, which are often characterized as constitutional isomers. Constitutional isomers are compounds that have the same general empirical formula but differ in their constitution, i.e. in their structure, such that they can have a different sequence of the atoms and/or different bonds. Constitutional isomers are therefore fundamentally different from stereoisomers, which include both enantiomers and diastereomers.

Constitutional isomers are in many cases grouped into functional isomers, skeletal isomers, positional isomers and bonding isomers. In the case of functional isomers and bonding isomers, the compounds can have different reactivity; for example, ethanol comprises a hydroxyl group, whereas the constitutionally isomeric dimethyl ether has an ether group. Skeletal isomers and positional isomers differ in the branching and/or the position of functional groups, such that these constitutional isomers can have essentially the same functionality. The expression “essentially the same functionality” accordingly means that the underlying functional group, i.e., for example, a hydroxyl group, a phenyl ring or an ester group, is present in all constitutional isomers, but does not take account of altered reactivity of these groups as a result of different substitution. For example, there is a measurable difference in the reactivity of 1-n-butanol and tert-butanol owing to the stereochemistry, but the functionality as such is identical. In this connection, however, these measurable differences that are covered by the term “essentially the same functionality” are to be neglected, since both compounds in the present case have a hydroxyl functionality. On the other hand, propyne has one alkyne functionality and propadiene has two alkene functionalities. Alkenes, by comparison with alkynes, have a different functionality in the context of this invention, since they exhibit different acidity, for example. Therefore, propyne, by comparison with propadiene, does not have “essentially the same functionality”.

The mixtures of the present derivatized alkyl polyglucosides have essentially the same functionality. Accordingly, components of the mixture, while constitutional isomers, are not functional isomers, and instead are skeletal isomers and/or positional isomers. That is, the functional group may be in a different position on the same carbon chain or on the same sugar molecule and have essentially the same functionality.

The term “alkyl” refers to a straight or branched chain monovalent hydrocarbon radical having a specified number of carbon atoms. Alkyl groups may be unsubstituted or substituted with substituents that do not interfere with the specified function of the composition and may be substituted once or twice with the same or different group. Substituents may include alkyl, aryl, alkoxy, hydroxy, mercapto, amino, alkyl substituted amino, nitro, carboxy, carbanyl, carbanyloxy, cyano, methylsulfonylamino, or halogen, for example. Examples of “alkyl” include, but are not limited to, methyl, ethyl, n-propyl, isopropyl, n-butyl, s-butyl, t-butyl, n-pentyl, n-hexyl, 3-methylpentyl, and the like.

The term “surfactant”, “surface active agent”, “surfactant”, or “dispersing agent” refers to an organic chemical that when added to a liquid changes the properties of that liquid at a surface.

Embodiments of the present invention are ethylene oxide and 1,4-dioxane free.

Alkyl polyglucosides are complex products made by the reaction of glucose and fatty alcohol. In dealing with the chemistry one talks about degree of polymerization (the so called “d.p.”). In the case of traditional alkyl polyglycosides the d.p. is around 1.4. This means that on average the is 1.4 units of glucose for each alkyl group. The fact of the matter is that the resulting material is a mixture having an average of 1.4.

The specific structure of the product is hard to ascertain completely since many positional isomers are possible, but two examples of structures are as follows:

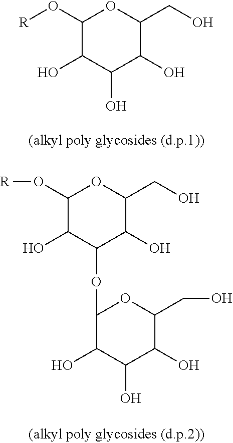

It should be clear that if there is a 50/50 mixture of the d.p. 1 and d.p. 2 product, the resulting analytical data will show that on average there is a d.p. of 1.5. Saying that a molecule has a d.p. of 1.5 does not mean that each molecule has 1.5 glucose units on it.

In one embodiment of the present invention, the surfactant is one that is disclosed in U.S. Pat. No. 6,627,612, incorporated herein by reference; and/or surfactants sold by Colonial Chemical, Inc. under the brand names Suga® Nate and Suga® Fax.

Another embodiment of the present invention is a surfactant disclosed in U.S. Pat. No. 6,958,315, incorporated herein by reference; and/or surfactants sold by Colonial Chemical, Inc. under the brand name Suga® Glycinate.

Another embodiment of the present invention is a surfactant disclosed in U.S. Pat. No. 8,268,766, incorporated herein by reference; and/or surfactants sold by Colonial Chemical, Inc. under the brand name Poly Suga® Mulse.

Another embodiment of the present invention is a surfactant disclosed in U.S. Pat. No. 7,507,399, incorporated herein by reference; and/or surfactant sold by Colonial Chemical, Inc. under the brand names Poly Suga® Quats, PolySuga® Nates, PolySuga® Phos.

Another embodiment of the present invention is a surfactant disclosed in U.S. Pat. No. 7,087,571, incorporated herein by reference; and/or surfactants sold by Colonial Chemical, Inc. under the brand name Suga® Mates.

Another embodiment of the present invention is a surfactant disclosed in U.S. Pat. No. 7,335,627, incorporated herein by reference; and/or surfactants sold by Colonial Chemical, Inc. under the brand name Poly Suga® Carb.

Other embodiments of the present invention include surfactants that are sugar-based sulfonate-, phosphate-, glycinate-, sulfosuccinate-, and carboxylate-containing surfactants derived from alkyl polyglucosides, including those disclosed in U.S. Pat. Nos. 6,627,612; 6,958,315; 7,087,571; 7,507,399 and 7,335,627.

Surfactants of the present invention may work alone or in combination with nonionic, alkyl polyglucoside-based sorbitan-ester crosspolymers (including those disclosed in U.S. Pat. No. 8,268,766). The latter crosspolymers of sorbitan esters and APG's are also very effective surfactants, wetting and stability of pigments and/or minerals in a liquid carrier.

The compositions of the present invention include a single embodiment, or mixture, used alone or in combination with an additional embodiment. The additional embodiment can be in the role of a co-surfactant.

Other co-surfactants can be included in the mixtures of the present invention. Examples of the co-surfactants include ionic and nonionic surfactants.

These derivatized alkyl polyglucosides are naturally derived, do not possess polyoxyethylene groups (or contain residual ethylene oxide monomer or 1,4-dioxane), are biodegradable and in many cases have been found to have very low skin and eye irritation.

In one embodiment the derivatized alkyl polyglucoside is chosen from a carboxymethyl derivatized alkyl polyglucoside, a quaternary derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

In another embodiment of the present invention, the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

In another embodiment of the present invention, the surfactant is a sorbitan ester alkylglucoside crosspolymer, more specifically a sorbitan ester oleate decylglucoside crosspolymer.

In another embodiment of the present invention, the surfactant is an alkoxylated alkyl polyglucoside as described in U.S. Pat. No. 6,800,741.

In one embodiment of the present invention, the derivatized polyglucoside surfactant of the present invention comprises a monosaccharide unit, a disaccharide unit, a linker, and a functionalizing agent.

In this regard, a derivatized alkyl polyglucoside composition of the present invention includes the following, as a mixture:

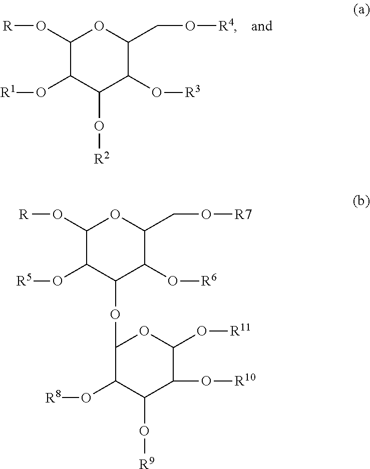

wherein:
R is an alkyl chain having 8 to 22 carbon atoms
R¹, R², R³, R⁴ R⁵, R⁶, R⁷, R⁸, R⁹, R¹⁰, and R¹¹ are independently selected from the group consisting of: —CH₂—C(O)—O⁻M⁺, or —C(O)CH₂—C(O)—O⁻M⁺

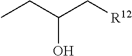

and H, with the proviso that R¹-R¹¹ are not all H;
R¹² is selected from the group consisting of:
—OH, —SO₃⁻M⁺, and —SO₄⁻²M⁺, —O—P(O)—(OM)₂,
—N(CH₃)₂—R^{1A}, —O—C(O)—CH₂—OH(SO₃⁻M⁺)—C(O)—O⁻M⁺,

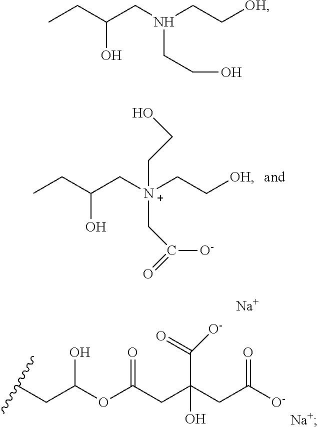

R^{1A} is CH₃—(CH₂)ₙ—;
M is a charge balancing group selected from H, Na, K, or NH₄⁻; and
n is an integer from 0-36;
and positional isomers thereof.

In one embodiment of the present invention, the derivatized polyglucoside surfactant of the present invention comprises a monosaccharide unit, a disaccharide unit, a crosslinking agent, and a functionalizing agent.

In this regard, a derivatized alkyl polyglucoside composition of the present invention includes the following, as a mixture:

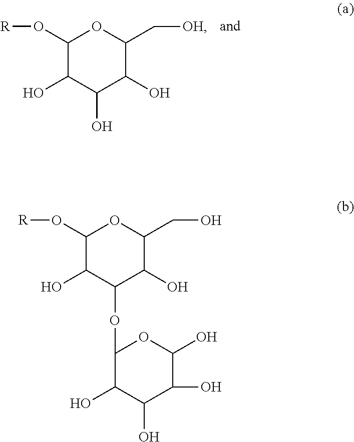

wherein:
R is an alkyl chain having 8 to 22 carbon atoms;
a crosslinking agent; and
a functionalizing agent selected from:

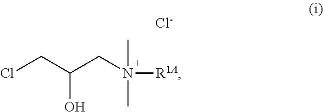

Cl—CH₂—CH(OH)—SO₃M, Cl—CH₂—CH(OH)—SO₄M, Cl—CH₂—CH(OH)—CH₂—OP(O)—(OM)₂, and combinations thereof, wherein
R^{1A} is CH₃(CH₂)ₙ—;
(ii) —Cl—CH₂—C(O)⁻Na⁺, 2-halocarboxylic acid, α, β-unsaturated carboxylic acid, cyclic carboxylic acid anhydride, and combinations thereof;

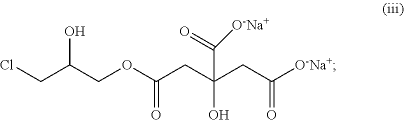

M is a charge balancing group selected from H, Na, K, or NH₄⁺; and
n is an integer from 0-36;
   and positional isomers thereof.

Crosslinking agents for the polyfunctionalized alkyl polyglucosides described immediately above include, but are not limited to, 1,3-dichloro-2-propanol and epichlorohydrin.

Thus, in one embodiment of the present invention is a phosphate and/or sulfonate functionalized alkyl polyglucoside of the following compounds, as a mixture, are useful as pigments surfactants, wetting agents, and stabilizers:

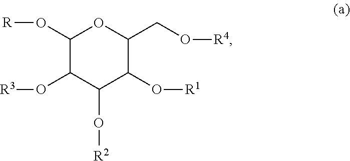

wherein:
R is an alkyl chain having 8 to 22 carbon atoms;
R¹, R², R³, and R⁴ are independently selected from the group consisting of:

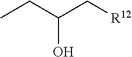

and H, with the proviso that R¹, R², R³, and R⁴ are not all H;
R¹² is selected from the group consisting of:
—OH, —SO₃⁻M⁺, —SO₄⁻²M⁺, and —O—P(O)—(OM)₂;
M is selected from the group consisting of Na, K, NH⁴;
and

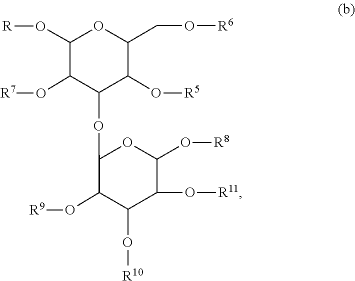

wherein
R⁵, R⁶, R⁷, R⁸, R⁹, R¹⁰, and R¹¹ are independently selected from the group consisting of:

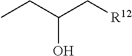

### and H; and

R¹² is selected from the group consisting of:
—OH, —O—P(O)—(OM)₂, —SO₃⁻M⁺, and —SO₄⁻²M⁺, and M is selected from the group consisting of Na, K, NH⁴;
   and positional isomers thereof.

These alkyl polyglucoside surfactants are manufactured by Colonial Chemical, Inc., South Pittsburgh, TN 37380. Two examples of which are sodium laurylglucosides hydroxypropylsulfonate (sold under the brand name Suga® Nate 160NC) and sodium decylglucosides hydroxypropylsulfonate (sold under the brand name Suga® Nate 100NC). The alkylpolyglucoside phosphates of the current invention are manufactured by Colonial Chemical, In., South Pittsburgh, TN 37380. An example of which is Sodium Decylglucosides Hydroxypropyl Phosphate, sold under the brand name Suga® Fax D10NC.

These surfactants are synthesized by the methods outlined in U.S. Pat. No. 6,627,612 or their corresponding patents and are generally supplied as clear solutions, 30-50% solids, that are used as pigment or mineral surfactants.

The phosphate functionalized alkyl polyglucoside surfactant additive of this embodiment are also described in U.S. Pat. No. 8,216,994. Thus, phosphate functionalized alkyl polyglucosides of the present invention include those with the following formula:

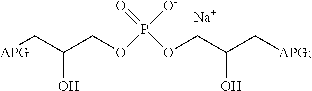

wherein APG is alkyl polyglucoside; and positional isomers thereof. In some embodiments, the alkyl moiety contains about 12 carbon atoms. An example of a suitable phosphate functionalized alkyl polyglucoside includes, but is not limited to, sodium dilaurylglucoside hydroxypropyl phosphate.

The sulfonated functionalized alkyl polyglucoside surfactants of this embodiment are also described in U.S. Pat. No. 8,216,988. Thus, sulfonated functionalized alkyl polyglucosides of the present invention include those with the following formula:

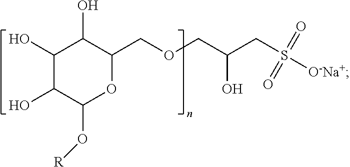

wherein n is between 1 to about 3, and particularly 1.5; and positional isomers thereof. R is an alkyl chain. Examples of suitable sulfonated functionalized alkyl polyglucosides include sodium laurylglucosides hydroxypropyl sulfonate and sodium declyglucosides hydroxypropyl sulfonate and combinations thereof.

An additional embodiment of the present invention is also a glycinate-modified alkylpolyglucoside surfactants represented by compounds of the following formulae, and positional isomers thereof, as a mixture:

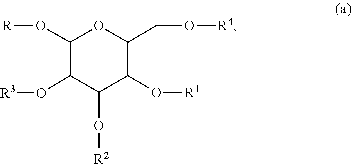

wherein
R is alkyl having 1 to 22 carbon atoms;
R¹, R², R³, and R⁴ are independently selected from

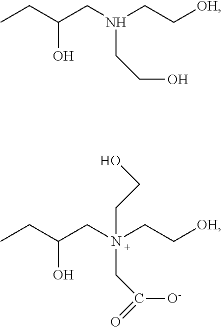

and H, with the proviso that R¹, R², R³, and R⁴ are not all H;
and

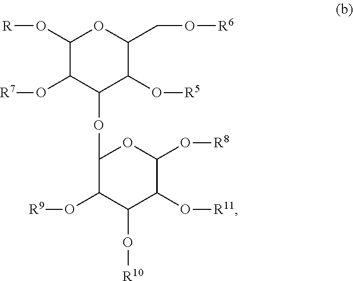

wherein
R is alkyl having 8 to 22 carbon atoms;
R⁵, R⁶, R⁷, R⁸, R⁹, R¹⁰, and R¹¹ are independently selected from

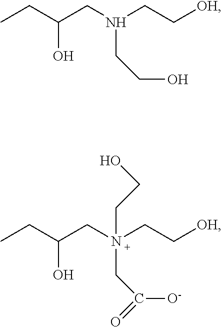

and H, with the proviso that R⁵, R⁶, R⁷, R⁸, R⁹, R¹⁰, and R¹¹ are not all H;
and positional isomers thereof.

The alkylpolyglucoside glycinates of the current invention are manufactured by Colonial Chemical, Inc., South Pittsburgh, TN 37380, two examples of which are Sodium Bis-Hydroxyethylglycinate Coco-Glucosides Crosspolymer (sold under the brand name Poly Suga® Glycinate C) and Sodium Bis-Hydroxyethylglycinate Lauryl-Glucosides Crosspolymer (sold under the brand name Poly Suga® Glycinate L).

These surfactants are synthesized by the methods outlined in U.S. Pat. No. 6,958,315 and are generally supplied as clear solutions, 30-50% solids, that are used as pigment or mineral surfactants.

An embodiment of the present invention is also crosspolymers of alkylpolyglucosides and sorbitan esters as sugar-based nonionic surfactants, represented as compounds of the following formulae, and positional isomers thereof, as a mixture:

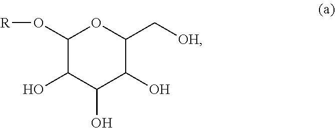

wherein;
R is alkyl having 8 to 22 carbon atoms; and

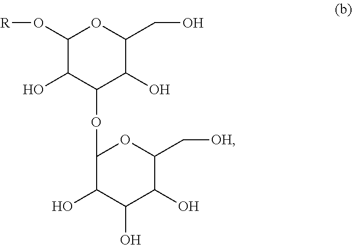

wherein:
R is alkyl having 8 to 22 carbon atoms; and
(c) a sorbitan ester of the following structure:

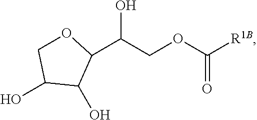

wherein:
R^{1B} is alkyl having 7 to 21 carbons;
a crosslinking agent of the following structure:

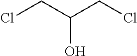

in water; and
optionally a functionalizing agent selected from the group of:

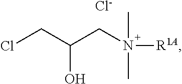

Cl—CH₂—CH(OH)—SO₃M, Cl—CH₂—CH(OH)—SO₄M,
Cl—CH₂—CH(OH)CH₂—OP(O)—(OM)₂, and mixtures thereof;
wherein R^{1A} is CH₃—(CH₂)ₙ—,
n is an integer from 0 to 36;
M is a charge balancing group selected from H, Na, K, or NH₄;
and positional isomers thereof.

The crosspolymers of alkylpolyglucosides and sorbitan esters that are the sugar-based nonionic surfactants of the current invention are manufactured by Colonial Chemical, Inc., South Pittsburgh, TN 37380, two examples of which are Poly Suga® Mulse D6 and Poly Suga® Mulse D9, both described as sorbitan oleate decylglucoside crosspolymer.

These surfactants are synthesized by the methods outlined in U.S. Pat. No. 8,268,766. The ratio of alkyl polyglucoside monomer to sorbitan ester monomer in the cross polymers can vary from 20:1 to 1:1, respectively.

An embodiment of the present invention is also sulfonate-modified, phosphate-modified and cationically modified poly-sugar alkyl polyglucoside surfactant additive, represented by compounds of the following formulae, as a mixture:

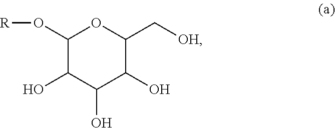

wherein;
R is alkyl having 8 to 22 carbon atoms; and

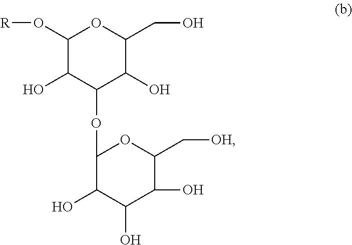

wherein:
R is alkyl having 8 to 22 carbon atoms;
a crosslinker of the following formula: Cl—CH₂—CH(OH)—CH₂—Cl; and
a functionalizing agent selected from:

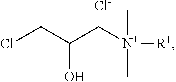

Cl—CH₂—CH(OH)—SO₃M,
Cl—CH₂—CH(OH)—SO₄M,
Cl—CH₂—CH(OH)CH₂—OP(O)—(OM)₂,
and mixtures thereof;
wherein R¹ is CH₃—(CH₂)ₙ—;
n is an integer from 0 to 36;
M is a charge balancing group selected from H, Na, K, or NH₄;
and positional isomers thereof.

These alkyl polyglucosides of the current invention are manufactured by Colonial Chemical, Inc., South Pittsburgh, TN 37380, as shown in U.S. Pat. No. 7,507,399. Examples of these alkyl polyglucosides are: sodium hydroxypropyl phosphate decylglucoside crosspolymer (Poly Suga® Phos 1000P), sodium hydroxypropyl phosphate laurylglucoside crosspolymer (PolySuga® Phos 1200P), Sodium hydroxypropyl phosphate cocoglucoside crosspolymer (PolySuga® Phos 8600P), Sodium hydroxypropyl sulfonate butylglucoside crosspolymer (PolySuga® Nate 40P), Sodium hydroxypropyl sulfonate decylglucoside crosspolymer (PolySuga® Nate 100P), Sodium hydroxypropyl sulfonate laurylglucoside crosspolymer (PolySuga® Nate 160P NC), Polyquaternium-78 (Poly Suga® Quat L-1010P), Polyquaternium-80 (Poly Suga® Quat L-1210P) and Polyquaternium-81 (Poly Suga® Quat S-1201P).

Another description of this embodiment is described in U.S. Pat. No. 8,329,633. Thus, poly quaternary functionalized alkyl polyglucosides of the present invention have the following formula:

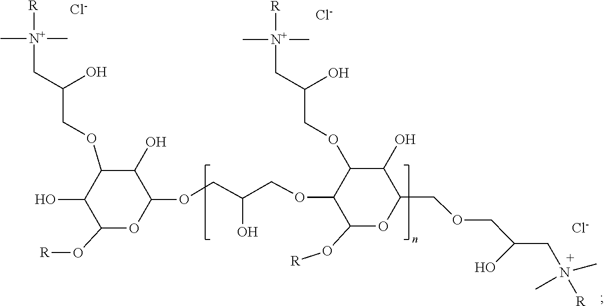

wherein R is an alkyl group having from about 8 to about 22 carbon atoms and n is an integer ranging from 4 to 6; and positional isomers thereof.

Another description of this embodiment is described in U.S. Pat. No. 8,262,805. Thus, poly sulfonate functionalized alkyl polyglucosides of the present invention have the following formula:

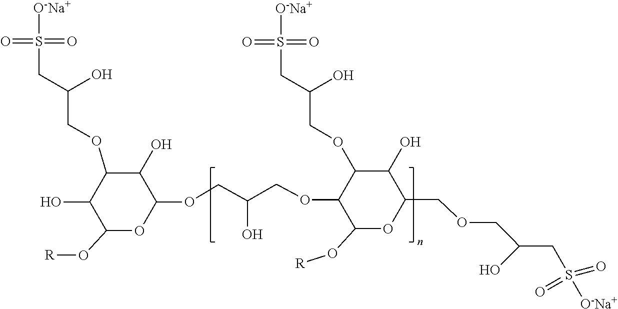

wherein R is an alkyl group having from about 8 to about 22 carbon atoms and n is an integer ranging from 4 to 6; and positional isomers thereof.

Another example of this embodiment is described in U.S. Pat. No. 8,287,659. That is, polyphosphate functionalized alkyl polyglucosides of the following formula:

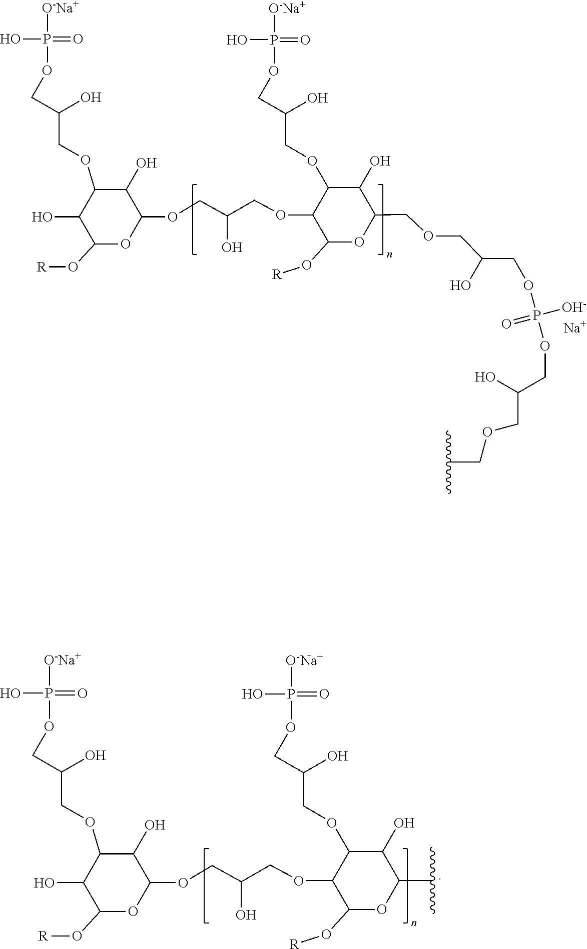

wherein R is an alkyl group having from about 8 to about 22 carbon atoms; and positional isomers thereof.

Another surfactant of the present invention is also described in U.S. Pat. Nos. 8,557,760 and 8,389,457. Quaternary functionalized alkyl polyglucosides of the present invention may have the following representative formula:

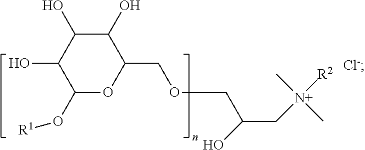

wherein R¹ is an alkyl group having from about 8 to about 22 carbon atoms, and R² is CH₃(CH₂)ₙ, and n is independently an integer from 0-21; and positional isomers thereof. Examples of suitable quaternary functionalized alkyl polyglucosides surfactants include those in the R¹ alkyl moiety contains primarily about 12 carbons, the R² group is CH₃.

Embodiments of the present invention also include sulfosuccinate-modified, alkylpolyglucoside surfactants, represented by compounds of the following formulae, as a mixture:

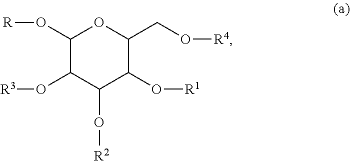

wherein
R is alkyl having 8 to 22 carbon atoms;
R¹, R², R³, and R⁴ are independently selected from —CH₂—CH(OH)—CH₂—R¹², and H,
with the proviso that R¹, R², R³, and R⁴ are not all H;
R¹² is —O—C(O)—CH₂—CH(SO₃ M⁺)—C(O)—O⁻ M⁺
M is a charge balancing group selected from H, Na, K, or NH₄;
and

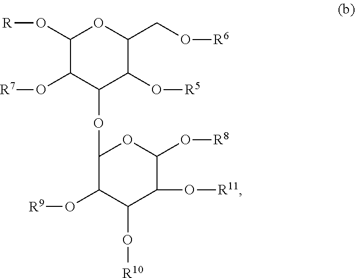

wherein
R is alkyl having 8 to 22 carbon atoms;
R⁵, R⁶, R⁷, R⁸, R⁹, R¹⁰, and R¹¹ are independently selected from —CH₂—CH(OH)—CH₂—R¹², and H,
with the proviso that R⁵, R⁶, R⁷, R⁸, R⁹, R¹⁰, and R¹¹ are not all H;
R¹² is —O—C(O)—CH₂—CH(SO₃ M⁺)—C(O)—O⁻ M⁺
M is a charge balancing group selected from H, Na, K, or NH₄;
and positional isomers thereof.

The sulfosuccinate-modified PolySuga® alkylpolyglucosides of the current invention are manufactured by Colonial Chemical, Inc., South Pittsburgh, TN 37380. These surfactants are synthesized by the methods outlined in U.S. Pat. No. 7,087,571 and are generally supplied as clear solutions, 30-50% solids, that are used as pigment or mineral surfactants.

Another embodiment of the present invention is carboxymethyl-modified, Poly Suga®-alkylpolyglucoside surfactants, represented by the following components, as a mixture:

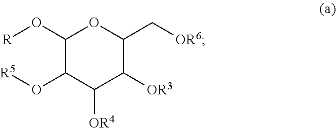

wherein one of R³, R⁴, R⁵, and R⁶ is —CH₂—C(O)—O⁻ M⁺ or —C(O)—CH₂—C(O)—O⁻ M⁺, with the remaining R groups being H; R is alkyl having 6 to 30 carbon atoms; M is H, Na, or K; and
(b) a 1,3 dichloro-2-propanol crosslinker;
and positional isomers thereof.

The carboxymethyl-modified Poly Suga® alkyl polyglucosides of the current invention are manufactured by Colonial Chemical, Inc., South Pittsburgh, TN 37380, examples of which are Sodium Maleate Decylglucoside Crosspolymer (Poly Suga® Carb DM), Sodium Maleate Laurylglucoside Crosspolymer (Poly Suga® Carb LM) and Sodium Succinate Laurylglucoside Crosspolymer (Poly Suga® Carb LS).

These surfactants are synthesized by the methods outlined in U.S. Pat. No. 7,335,627 and are generally supplied as clear solutions, 40-60% solids, that are used as pigment surfactants.

Another embodiment of the present invention is a citrate-functionalized polymeric alkylglucoside surfactant, represented by the following components, as a mixture:

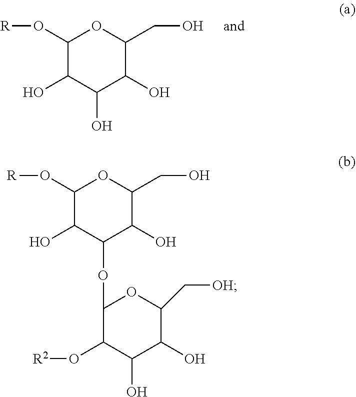

wherein R is an alkyl having 8 to 22 carbons, and R² is:

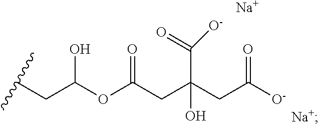

and positional isomers thereof. The citrate-modified alkyl polyglucosides of the current invention are manufactured by Colonial Chemical, Inc., South Pittsburgh, TN 37380, an example of which is Disodium Laurylglucosides Hydroxypropyl Citrate (Suga® Citrate L1C)

The functionalized alkylpolyglucosides of the present invention have found wide application mostly in the personal care market in various cleansing products such as shampoos, body washes and facial washes. Additionally, their use in household, industrial and institutional cleaning has been the subject of a number of patents. The Suga® Quats and Poly Suga® Quats surfactants mentioned above have been patented for use in various hard-surface cleaning applications (outlined in U.S. Pat. Nos. 8,557,760; 8,389,457; 8,329,633; 8,877,703; 10,035,975; and U.S. Pat. No. 9,474,703 issued to Ecolab USA Inc.). The Suga® Nate and Poly Suga® Nate surfactants mentioned above have also been patented for use in various hard-surface cleaning applications (U.S. Pat. Nos. 8,071,520; 8,216,988; and 8,262,805 issued to Ecolab USA Inc.). The Poly Suga® Glycinates mentioned above have also been patented for use in various hard-surface cleaning applications (U.S. Pat. No. 8,299,099 issued to Ecolab USA Inc.). The Suga® Fax and Poly Suga® Fax surfactants mentioned above have also been patented for use in various hard-surface cleaning applications (U.S. Pat. Nos. 8,216,994; 8,287,659; and 8,969,285 issued to Ecolab USA Inc.). The Poly Suga® Mates surfactants mentioned above have been patented for use in various hard-surface cleaning applications of (U.S. Pat. No. 8,658,584 issued to Ecolab USA Inc.).

The coating agents of the present invention may be formed by conventional techniques known in the art. For example, the process may take place in any of the customary mixing systems. As one example, the components may be added into a mix and tumbled or mixing augured. The liquid is then sprayed onto the granules using conventional liquid delivery systems while final blending or tumbling is taking place. The process may either be in a continuous or batch process. Drying of the granules is an optional step that may not be necessary depending on the blending operation selected. Those of ordinary skill in the art recognize that thorough mixing and blending impact the degree of coating on the fertilizer granules.

With respect to the carrier, one of ordinary skill in the art would understand that there are many workable options. For example, the carrier can be, but not limited to, water, or any hydroscopic carrier such as polymer, petroleum or plant-based oils, asphalts, rosins, pitch, fatty acids, petroleum or natural based waxes, VTAE.

In some embodiments, the carrier can be a solvent described in U.S. Pat. No. 10,815,160. That is, the carrier or solvent may be selected from mineral oils, paraffins and waxes derived from petroleum and animal fats and oils, and wherein the solvent content is 50% wt. or more, based on the total weight of the composition.

In another embodiment of the invention, preferred carriers are mineral oils, specially preferred are paraffin oils or mixtures of paraffin oils with macrocrystalline paraffins and microcrystalline paraffins; and vegetal and animal fats and oils such as rapeseed oil, palm oil or tallow. The carrier of the invention may be chosen from various mineral oils, paraffins and waxes derived from petroleum. Suitable mineral oils, paraffins and waxes from petroleum according to the present invention include aromatic oils, which are a mixture of mineral oils from petroleum with a high content of components having aromatic type rings; white mineral oils, which are highly refined petroleum derivatives, generally used as carriers, excipients and lubricants in different industrial applications; paraffin oils, which are petroleum derivatives rich in paraffin components and have low density and a variable viscosity; macrocrystalline paraffins, which are petroleum derivatives containing mainly linear carbon chains with a molecular weight comprised between 250 and 500 and, although they are solids at room temperature, they have low melting points, usually comprised between 40° C. and 70° C.; microcrystalline paraffins, which are petroleum derivatives and are mainly saturated hydrocarbons in which linear chains with short branches (isoparaffins) are predominant. They usually have mean molecular weights comprised between 500 and 800, and are solids at room temperature, having melting points comprised between 70° C. and 100° C.

The solvent/carrier may also be chosen from animal or vegetable fats and oils. Suitable animal or vegetable fats and oils according to the present invention are esters of linear and/or branched, saturated and/or unsaturated alkanecarboxylic acids with a chain length of 1 up to 30 carbon atoms and linear and/or branched, saturated and/or unsaturated alcohols with a chain length of 1 up to 30 carbon atoms, of the group of esters of aromatic carboxylic acids and linear and/or branched, saturated and/or unsaturated alcohols with a chain length of 1 up to 30 carbon atoms. These oils can be advantageously selected from the group consisting of isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl laurate, 2-ethylhexyl palmitate, 2-ethylhexyl cocoate, 2-hexyldecyl stearate, 2-ethylhexyl isostearate, 2-octyldodecyl palmitate, cetyl palmitate, oleyl oleate, oleyl erucate, erucyl oleate, erucyl erucate, as well as synthetic, semisynthetic and natural mixtures of such esters, such as jojoba oil (a natural mixture of esters of monounsaturated monocarboxylic acids with a C18-C24 chain with also monounsaturated monoalcohols and with a long C18-C24 chain). Other suitable oils of the type of esters of saturated alkanecarboxylic acids and alcohols are fatty acid methyl esters, preferably C6-C24 fatty acid methyl esters from animal and vegetable fats and oils such as cotton, safflower, coconut, rapeseed, linseed, palm, palm kernel, sunflower, olein, olive, olive pomace, castor oil, tallow, soy, tall oil, etc., possibly totally or partially hydrogenated, as well as purified or synthetic fatty acids such as caproic acid, caprylic acid, capric acid, lauric acid, myristic acid, palmitic acid, palmitoleic acid, stearic acid, isostearic acid, 2-ethylhexanoic acid, oleic acid, ricinoleic acid, elaidic acid, petroselinic acid, linoleic acid, linolenic acid, arachidic acid, gadoleic acid, behenic acid and erucic acid, or mixtures thereof.

Other suitable animal or vegetable fats and oils according to the present invention are fatty acid triglycerides, specifically triglycerin esters of linear and/or branched, saturated and/or unsaturated alkanecarboxylic acids with a chain length of 6 up to 24 carbon atoms, preferably of 10 up to 18 carbon atoms. The fatty acids esterifying the different positions of glycerin can be different, giving rise to a large amount of possible combinations, including positional combinations. The position of the different fatty acids in natural triglycerides is not random, but rather it depends on the origin of the fat. The triglycerides more simple are those constituted by a sole fatty acid.

Fatty acid triglycerides can be selected, for example, from the group consisting of synthetic, semi-synthetic and natural oils, as for example, animal fats and oils such as cow tallow, pig lard, bone oil, aquatic animal fats and oils (fish, such as herring, cod or sardine; cetaceans; etc.); and vegetable fats and oils such as avocado oil, almond oil, hazelnut oil, babassu palm oil, borage oil, peanut oil, canola oil, hemp oil, milk thistle oil, safflower oil, chufa oil, coconut oil, rapeseed oil, black cumin oil, wheat germ oil, sunflower oil, linseed oil, macadamia nut oil, corn oil, walnut oil, olive oil and its by-products such as olive pomace oil, palm oil and its fractions such as palm olein and palm stearin, evening primrose oil, rosehip oil, castor oil, rice bran oil, apricot kernel oil, cottonseed oil, pumpkinseed oil, palm kernel oil and its fractions such as palm kernel olein and palm kernel stearin, grape seed oil, sesame oil, soy oil, cocoa butter, shea butter and the like.

In embodiments of the invention, the amount of the at least one active/surfactant is from about 5% to about 30% wt., or about 5% to about 50% wt., based on the total weight of the composition. In other embodiments of the invention, the amount of the carrier is 50% wt. or more, based on the total weight of the composition. Preferably, the carrier is contained in an amount, expressed as percentage by weight, of 55% to 90%, or about 65% to about 85%.

The compositions of the present invention can be obtained with a conventional process for mixing the different components, well known by the skilled person. For example, the different components can be mixed in molten state and once the mixture has been homogenized, it is packaged and possibly cooled.

The compositions object of the present invention have, in relation to solid fertilizers, a broad field of applications, since they are effective both for granular simple and granular complex fertilizers. The use of compositions object of this invention in solid fertilizers provides said fertilizers with an efficient resistance against caking, making the fertilizers to show excellent properties regarding their breakdown, even after their transport and storage period. Said use also forms part of the invention.

Of course, one of ordinary skill in the art would recognize that another object of the invention is the process for applying the anticaking compositions. These processes are well known by the skilled person and consist, for example, but not limited to, in applying the compositions according to the invention, in molten state, by means of spraying technique, on the surface of the solid fertilizer, once such fertilizer has been manufactured.

The amount of additive to be applied on the surface of the fertilizer will depend in each case on the humidity, storage time and temperature conditions expected for the storage of the fertilizer, although good results can be obtained when said compositions are applied on the fertilizer in proportions comprised between 500 and 5000 ppm with respect to the weight of the fertilizer, preferably between 700 and 3000 pm.

Fertilizer compositions, wherein solid fertilizers are coated by applying on the surface a composition according to the invention are also a part of the invention. A composition according to the invention can be applied to both types of fertilizers, granular simple fertilizers and granular complex fertilizers, being especially preferable for granular complex fertilizers of the NPK type and for ammonium nitrate type.

The invention thus being described, it would be understood to those of ordinary skill in the art that various changes in and from details may be made therein without departing from the scope of the invention disclosed herein.

1. A composition for preventing the caking of granular materials, comprising at least one active component that is a
derivatized carbohydrate such as alkyl derivatized polyglycosides, glycolipids, glycerol glycolipids, sphingo glycolipids, sulfolipids, phospholipids, glucosides, rhamnolipids, sophorolipids, and a carrier.

2. The composition of claim 1, wherein the active component comprises a crosspolymer of an alkyl polyglucoside.

3. The composition of claim 1, wherein the active component comprises at least one derivatized alkyl polyglucoside, and/or an alkyl polyglucoside sorbitan ester crosspolymer surfactant.

4. The composition of claim 1, wherein the granular materials are hygroscopic substrates; and the coating agent comprising an active component, a carrier, and additional hydrophobic components which may be petro and natural based oils and waxes.

5. The composition of claim 1, further comprising a granular fertilizer substrate.

6. The composition of claim 5, wherein the granular fertilizer substrate is at least one of MAP, DAP, SSP, TSP, AN, LDAN, AS, NPK, KCl, polyhalite, and KSO4, and combinations thereof.

7. The composition of claim 1, wherein the derivatized alkyl polyglucoside is chosen from a carboxymethyl derivatized alkyl polyglucoside, a quaternary derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

8. The composition of claim 1, wherein the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

9. The composition of claim 1, wherein the alkyl polyglucoside crosspolymer is a sorbitan ester alkylglucoside crosspolymer including sorbitan oleate decylglucoside crosspolymer.

10. The composition of claim 1, wherein the derivatized polyglucoside surfactant of the present invention comprises a monosaccharide unit, a disaccharide unit, a linker, and a functionalizing agent.

11. The composition of claim 1, wherein the derivatized polyglucoside surfactant of the present invention comprises a monosaccharide unit, a disaccharide unit, a crosslinking agent, and a functionalizing agent.

12. The composition of claim 1, wherein the derivatized carbohydrate is an alkyl derivatized polyglycosides that includes the following, as a mixture: 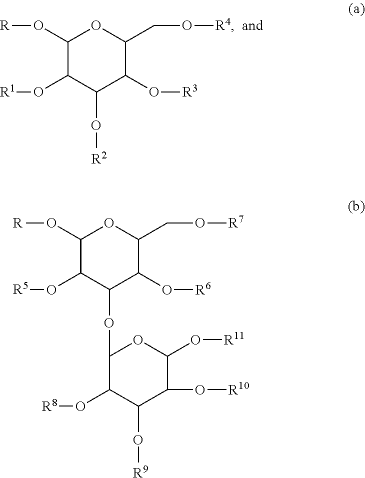
wherein:
R is an alkyl chain having 8 to 22 carbon atoms;
R¹, R², R³, R⁴ R⁵, R⁶, R⁷, R⁸, R⁹, R¹⁰, and R¹¹ are independently selected from the group consisting of: —CH₂—C(O)—O⁻M⁺, or —C(O)CH₂—C(O)—O⁻M⁺ 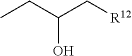
and H, with the proviso that R¹-R¹¹ are not all H;
R¹² is selected from the group consisting of:
—OH, —SO₃⁻M⁺, and —SO₄⁻²M⁺, —O—P(O)—(OM)₂,
—N(CH₃)₂—R^{1A}, —O—C(O)—CH₂—OH(SO₃⁻M⁺)—C(O)—O⁻M⁺, 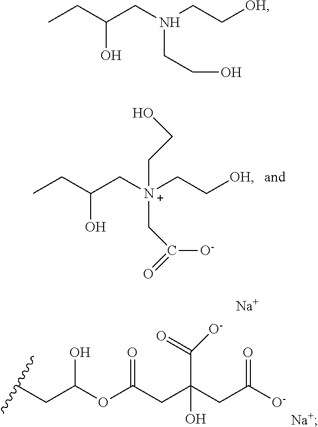
R^{1A} is CH₃—(CH₂)ₙ—;
M is a charge balancing group selected from H, Na, K, or NH₄⁺; and
n is an integer from 0-36;
and positional isomers thereof.

13. The composition of claim 1, wherein the derivatized alkyl polyglucoside surfactant is a composition that includes the following, as a mixture: 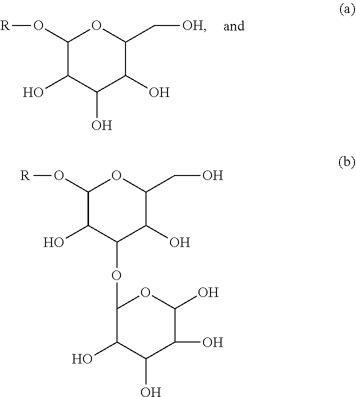
wherein:
R is an alkyl chain having 8 to 22 carbon atoms;
a crosslinking agent; and
a functionalizing agent selected from: 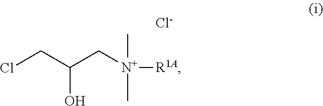
Cl—CH₂—CH(OH)—SO₃M, Cl—CH₂—CH(OH)—SO₄M, Cl—CH₂—CH(OH)—CH₂—OP(O)—(OM)₂, and combinations thereof, wherein
R^{1A} is CH₃(CH₂)ₙ—;
(ii) —Cl—CH₂—C(O)—O—⁻Na⁺, 2-halocarboxylic acid, α, β-unsaturated carboxylic acid, cyclic carboxylic acid anhydride, and combinations thereof; 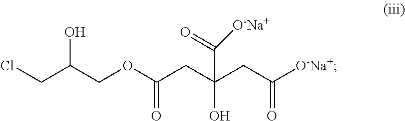
M is a charge balancing group selected from H, Na, K, or NH₄⁺; and
n is an integer from 0-36;
and positional isomers thereof.

14. The composition of claim 1, wherein the alkyl polyglucoside sorbitan ester crosspolymer surfactant is a composition that includes the following, as a mixture: 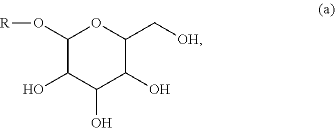
wherein;
R is alkyl having 8 to 22 carbon atoms; and 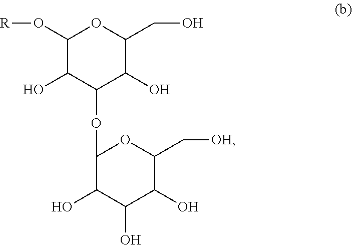
wherein:
R is alkyl having 8 to 22 carbon atoms; and
(c) a sorbitan ester of the following structure: 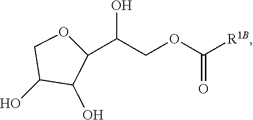
wherein:
R^{1B} is alkyl having 7 to 21 carbons;
a crosslinking agent of the following structure: 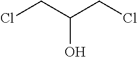
in water; and
optionally a functionalizing agent selected from the group of: 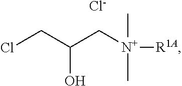
Cl—CH₂—CH(OH)—SO₃M, Cl—CH₂—CH(OH)—SO₄M,
Cl—CH₂—CH(OH)CH₂—OP(O)—(OM)₂, and mixtures thereof;
wherein R^{1A} is CH₃—(CH₂)ₙ—,
n is an integer from 0 to 36;
M is a charge balancing group selected from H, Na, K, or NH₄;
and positional isomers thereof.

15. The composition of claim 1, further comprising a co-surfactant.

16. The composition of claim 15, wherein the co-surfactant is a derivatized alkyl polyglucoside or alkyl polyglucoside sorbitan ester crosspolymer surfactant that is ethylene oxide and 1,4-dioxane free.

17. The composition of claim 15, wherein the co-surfactant is selected from alkyl polyglucosides, alkyl polyglucoside sorbitan ester crosspolymers, fatty alcohol ethoxylates, alkylphenol ethoxylates, phosphate esters of fatty alcohols, phosphate esters of fatty alcohol ethoxylates, phosphate esters of alkylphenol ethoxylates, sulfates of fatty alcohols, sulfates of fatty alcohol ethoxylates, sulfates of alkylphenol ethoxylates, sulfonates of fatty alcohols, sulfonates of fatty alcohol ethoxylates, sulfonates of alkylphenol ethoxylates, ethoxylated terpenes, phosphate esters of ethoxylated terpenes, sulfates of ethoxylated terpenes, sulfonates of ethoxylated terpenes, sulfosuccinates, quaternary amines, betaines, carboxymethylated fatty alcohols, carboxymethylated fatty alcohol ethoxylates, carboxymethylated alkylphenol ethoxylates, polyacrylic acid polymers, polymethacrylic acid polymers, gemini surfactants, or tertiary amine surfactants.

18. A method for obtaining solid fertilizers resistant to caking, wherein the solid fertilizer particles are coated; or are mixed with a composition comprising a composition of claim 1.

19. A fertilizer with reduced caking, comprising:
(i) a solid, granular fertilizer; and
(ii) a composition of claim 1.

20. A method of reducing caking or agglomeration in a granular or compacted substrate, comprising:
combining a coating additive of claim 1; and
coating a granular or compacted product with the coating additive, where the coating can be applied heated or applied at ambient temperature to the substrate.

21. The method of claim 20, wherein the coating additive is applied through a spray nozzle or drip.

22. The method of claim 20, wherein the coating is further spread through any source of mixing, including a mixing drum, log mixer, screw mixer, or gravity.

23. The method of claim 20, wherein the active component can be applied neat at 100% or in combination with other components.

24. The method of claim 20, wherein the active component can be combined at a concentration of 5-30%.

25. The method of claim 20, wherein the carrier can be but not limited to water, or any hydroscopic carrier such as polymer, petroleum or plant-based oils, asphalts, rosins, pitch, fatty acids, petroleum or natural based waxes, VTAE.

26. The method of claim 20, wherein the substrate is fertilizer or LDAN.
